(19) United States
(12) Patent Application Publication
(10) Pub. No.: US 2017/0293554 A1
(43) Pub. Date: Oct. 12, 2017

(54) HARDWARE-ASSISTED GARBAGE COLLECTION

(71) Applicant: Google Inc., Mountain View, CA (US)

(72) Inventor: Dmitry Grinberg, Mountain View, CA (US)

(73) Assignee: Google Inc., Mountain View, CA (US)

(21) Appl. No.: 15/203,641

(22) Filed: Jul. 6, 2016

Related U.S. Application Data
(60) Provisional application No. 62/321,516, filed on Apr. 12, 2016.

(51) Int. Cl. G06F 12/02; G06F 9/455; G06F 12/1009

(52) U.S. Cl. CPC G06F 12/0253; G06F 12/1009; G06F 9/45558; G06F 2009/45583; G06F 2212/657; G06F 2212/702

(57) ABSTRACT

An example method includes receiving, by a software module that is executed by at least one processor of a computing device, memory write information indicating that the at least one processor has not written any data to a storage area of a memory of the computing device since a prior point in time, the memory write information being associated with the storage area and being based on information generated by a management unit of the computing device, the management unit comprising a hardware component of the at least one processor to manage data retrieved from and data written to the memory, and the storage area including a first object stored in the memory. The example method further includes determining, by the software module and based on the memory write information, to refrain from performing garbage collection on a second object stored in the memory and referenced by the first object.

This application claims the benefit of U.S. Provisional Application No. 62/321,516, filed Apr. 12, 2016, the entire content of which is hereby incorporated by reference.

### BACKGROUND

Computing devices, such as mobile devices and/or desktop devices, typically execute various applications over a period of time. These applications may be based on source code that is created using one or more programming languages. When using high-level languages, such Java or JavaScript, automatic memory management is often part of the language and/or runtime environment. For example, a virtual machine that is used to execute applications often provides such memory management.

One issue that typically arises during application execution is the issue of garbage collection. Garbage collection is the process of determining which memory is currently unused and safe to free or re-allocate for use by one or more applications. As applications get larger and larger, garbage collection may potentially expend more and more processing cycles and execution bandwidth. One current approach for performing garbage collection includes traversing or checking all objects that were previously used or allocated by an application. A garbage collection mechanism may mark any objects that are still reachable or referenced by the application or by other objects. The objects that have not been marked may then be deleted by the garbage collection mechanism, such that the memory space associated with these unmarked objects may be freed or re-allocated for other use.

### SUMMARY

In one example, a method includes receiving, by a software module that is executed by at least one processor of a computing device, memory write information indicating that the at least one processor has not written any data to a storage area of a memory of the computing device since a prior point in time, wherein the memory write information is associated with the storage area and is based on information generated by a management unit of the computing device, wherein the management unit comprises a hardware component of the at least one processor that is configured to manage data retrieved from and data written to the memory, and wherein the storage area includes a first object that is stored in the memory. In this example, the method further includes determining, by the software module and based on the memory write information, to refrain from performing garbage collection on a second object that is stored in the memory and that is referenced by the first object.

In another example, a computer-readable storage device stores instructions that, when executed, cause at least one processor of a computing device to perform operations comprising receiving memory write information indicating that the at least one processor has not written any data to a storage area of a memory of the computing device since a prior point in time, wherein the memory write information is associated with the storage area and is based on information generated by a management unit of the computing device, wherein the management unit comprises a hardware component of the at least one processor that is configured to manage data retrieved from and data written to the memory, and wherein the storage area includes a first object that is stored in the memory. In this example, the operations further include determining, based on the memory write information, to refrain from performing garbage collection on a second object that is stored in the memory and that is referenced by the first object.

In another example, a computing device includes a memory and at least one processor communicatively coupled to the memory. The at least one processor includes a management unit comprising a hardware component that is configured to manage data retrieved from and data written to the memory. The memory is configured to store instructions that, when executed, cause the at least one processor to receive memory write information indicating that the at least one processor has not written any data to a storage area of a memory of the computing device since a prior point in time, wherein the memory write information is associated with the storage area and is based on information generated by a management unit of the computing device, and wherein the storage area includes a first object that is stored in the memory. In this example, the instructions, when executed, further cause the at least one processor to determine, based on the memory write information, to refrain from performing garbage collection on a second object that is stored in the memory and that is referenced by the first object.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that is configured to determine whether or not to perform garbage collection on one or more objects based at least in part on information generated by a management unit, in accordance with one or more aspects of the present disclosure.

FIG. 2 is a block diagram illustrating another example of the computing device that is configured to determine whether or not to perform garbage collection on one or more objects, in accordance with one or more aspects of the present disclosure.

FIG. 3 is a block diagram illustrating an example of a computing device, such as the computing device shown in FIG. 1 and/or FIG. 2, in accordance with one or more aspects of present disclosure.

FIG. 4 is a block diagram illustrating an example of a virtual machine receiving bitfield information from a kernel to determine whether or not to perform garbage collection on one or more objects, in accordance with one or more aspects of present disclosure.

FIG. 5 is a conceptual diagram illustrating example associations between bits included in bitfield information and respective virtual pages of a virtual memory space, in accordance with one or more aspects of present disclosure.

FIG. 6 is a conceptual diagram illustrating example mappings of virtual pages of a virtual memory space to respective physical pages of a physical memory, in accordance with one or more aspects of present disclosure.

FIG. 7 is a conceptual diagram illustrating an example layout of objects stored in virtual pages of a virtual memory space, in accordance with one or more aspects of present disclosure.

FIG. 8 is a flowchart illustrating example operations of a computing device, such as the computing device illustrated in FIG. 1, FIG. 2, and/or FIG. 3, in accordance with one or more aspects of the present disclosure.

### DETAILED DESCRIPTION

Examples described in this disclosure relate to techniques for performing hardware-assisted garbage collection. Garbage collection is the process of determining which memory is currently unused and safe to free or re-allocate for use by one or more applications. Certain approaches for performing garbage collection currently exist, but these approaches are typically implemented in software with no hardware assistance. As noted above, one current approach for performing garbage collection includes traversing or checking all objects previously used or allocated by an application when it is time to perform garbage collection. These objects are stored in memory. A garbage collection mechanism marks any objects that are reachable or referenced by the application or by other objects. The objects that have not been marked are deleted by the garbage collection mechanism, such that the memory space associated with these unmarked objects may be freed or re-allocated for other use. Conducting this process each time that garbage collection is performed, however, can be quite time consuming, as the process needs to occur in its entirety each time garbage collection is performed (e.g., at various different points in time for each garbage collection iteration), and all objects, such as objects in a conceptual object tree including parent objects and child objects, need to be checked.

Another approach to garbage collection builds on this first approach but further tracks which objects have been written to since the last time garbage collection was performed, such that parts of the prior object traversal to identify which objects are reachable may be used in the current garbage collection process. For example, if the memory space at which a particular object is stored has not been written to since the last time garbage collection was performed, such that the particular object has not effectively been touched, it may be safe to assume that this particular object still references any other objects that it previously referenced the last time garbage collection was performed. However, this approach to garbage collection incurs an additional runtime cost with respect to processing cycles and performance, because the software application must maintain additional state information associated with which objects have been touched in memory since the last garbage collection process.

Techniques of the present disclosure relate to techniques for performing hardware-assisted garbage collection. Using these techniques, software modules may make use of certain state information, which is generated by a hardware component and is stored in memory, to determine which objects stored in memory have been touched since the last time garbage collection was performed. Based on this determination, these software modules may be able to determine whether or not certain objects (e.g., child objects of parent objects) are to be garbage collected in the current garbage collection process. In various examples, as described herein, an object stored in memory is touched if the memory space at which the object is stored has been written to. In various examples, as also described herein, garbage collection refers to the process in which memory space that is not currently being referenced by an application or by at least one other object stored in memory is freed and made available for re-allocation. An object that is garbage collected may be deleted during the garbage collection process, and the memory space at which this object is stored is thereby freed for other use.

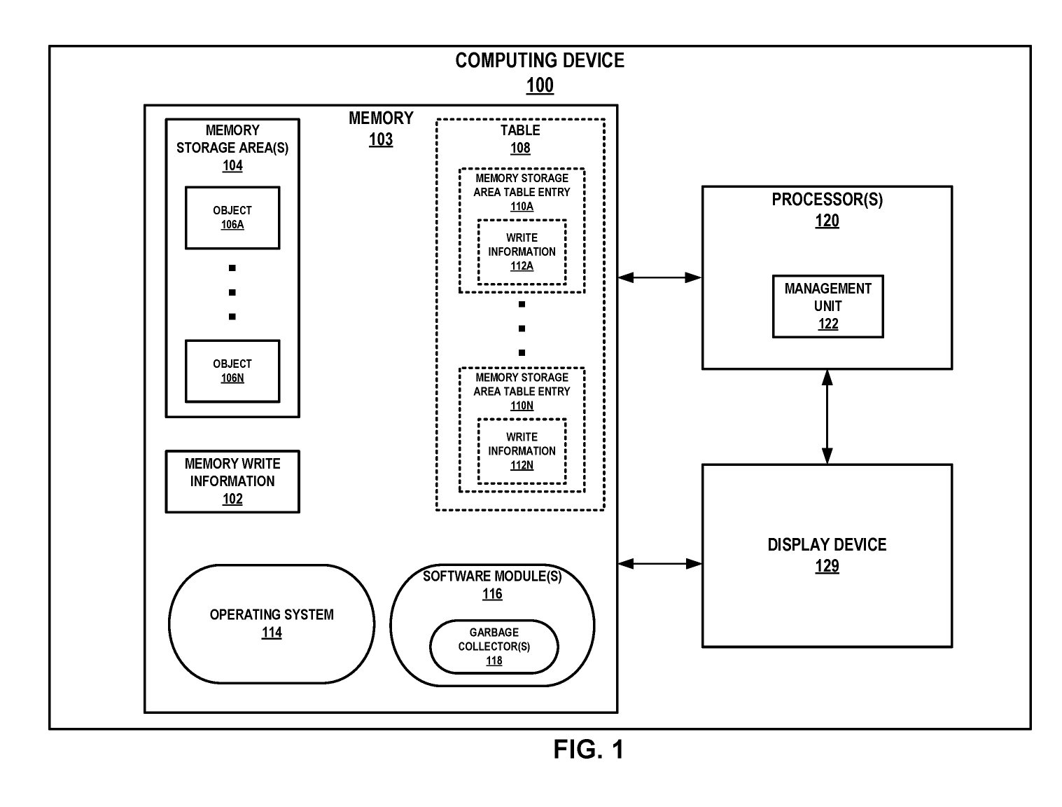

FIG. 1 is a block diagram illustrating an example computing device 100 that is configured to determine whether or not to perform garbage collection on one or more objects based at least in part on information generated by a management unit 122, in accordance with one or more aspects of the present disclosure. Examples of computing device 100 may include, but are not limited to, a mobile phone, a tablet computer, a personal digital assistant (PDA), a laptop computer, a portable gaming device, a portable media player, an e-book reader, a wearable computing device (e.g., a watch, a wrist-mounted computing device, a head-mounted computing device), a television platform, or other type of computing device. As will be described in further detail below, computing device 100 may be or include one or more processors 120.

As shown in FIG. 1, computing device 100 may, in some examples, include a display device 129 (e.g., a presence-sensitive display device). Display device 129 may have an input component and/or an output component. For instance, display device 102 may include a presence-sensitive input component, such as a resistive touchscreen, a surface acoustic wave touchscreen, a capacitive touchscreen, a projective capacitance touchscreen, a pressure-sensitive screen, an acoustic pulse recognition touchscreen, or another presence-sensitive technology. Display device 129 may include a display component, such as a liquid crystal display (LCD), dot matrix display, light emitting diode (LED) display, cathode-ray tube (CRT) display, organic light-emitting diode (OLED) display, e-ink, projector, or similar monochrome or color display capable of outputting information to a user of computing device 100.

As one example, display device 129 of computing device 100 may comprise a presence-sensitive display device, such as a touchscreen. Display device 129 may receive indications of tactile input by detecting one or more gestures from a user of computing device 100 (e.g., the user touching or pointing to one or more locations of display device 129 with a finger or a stylus pen). Display device 129 may present output in a graphical user interface, which may be associated with functionality provided by computing device 100. For example, display device 129 may present various graphical user interfaces associated with one or more software modules 116 and/or operating system 114 executing at computing device 100. A user may interact with a respective graphical user interface to cause computing device 100 to perform operations relating to corresponding functionality of software modules 116 and/or operating system 114. Display device 129 is communicatively coupled to processors 120 and to a memory 103.

In some examples, computing device 100 may include one or more communication units, which may send data to and/or receive data from one or more other computing devices. In some examples, these communication units support wireless and/or wired communication and may send and/or receive data using any variety of communication protocols.

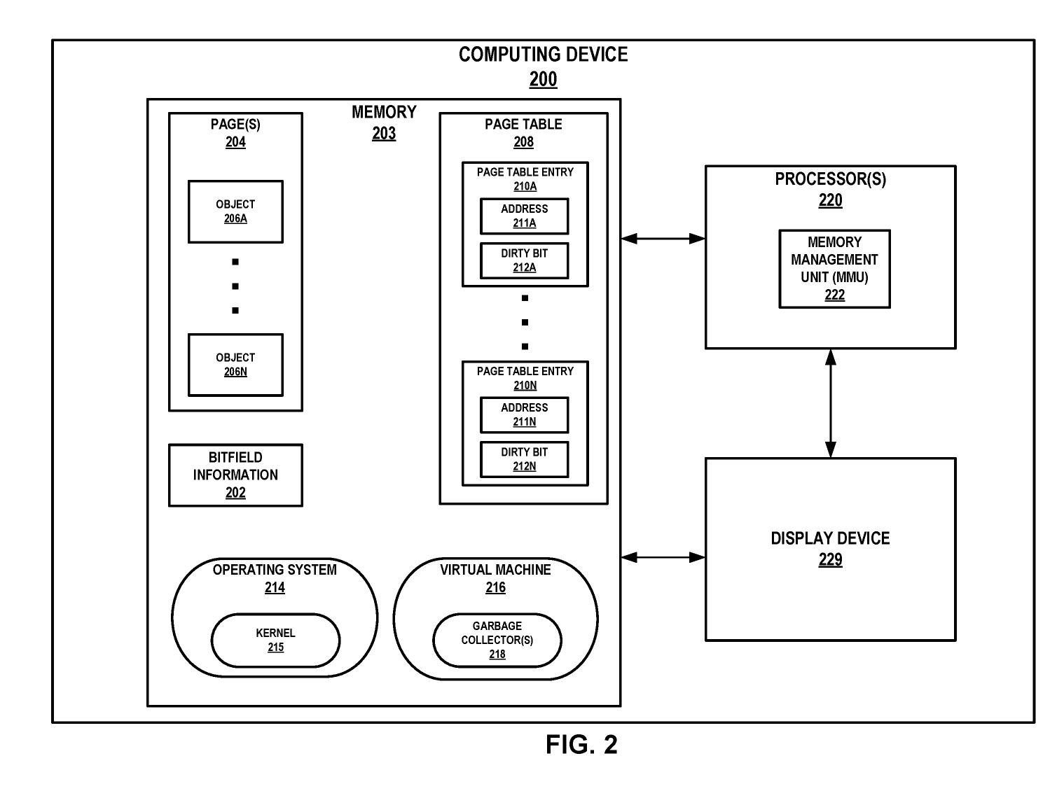

As shown in FIG. 1, computing device 120 includes one or more processors 120 and memory 103. As will be described in further detail below, processors 120 includes a management unit 122. Memory 103 includes one or more memory storage areas 104 (e.g., one or more pages, as shown in FIG. 2). Memory storage areas 104 store one or more objects 106A-106N (collectively, “objects 106). These objects may be created or otherwise used by one or more processes, such as by software modules 116 and/or operating system 114.

Operating system 114 may comprise one or more software modules that are stored in memory 103, and may include one or more instructions and/or programs that are executed by processors 120. One or more software modules 116 may also be stored in memory and may also include one or more instructions and/or programs that are executed by processors 120. For example, software modules 116 may comprise one or more software applications (e.g., an e-mail application, a map or navigation application, a calendar application, a messaging application, a social media application, a travel application, a game application, a stock application, a weather application, to name only a few non-limiting examples). In some examples, software modules 116 may comprise one or more virtual machines. As shown in FIG. 1, software modules 116 may include one or more garbage collectors 118.

Memory 103 also includes memory write information 102. Memory write information 102 may indicate whether or not processors 120 have written any data to one or more of memory storage areas 104 since a prior point in time. For example, memory write information 102 may indicate whether or not processors 120, during execution of operating system 114 and/or software modules 116, have written any data to one or more of memory storage areas 104 since the last time garbage collection of memory storage areas 104 was performed (e.g., by one or more of garbage collectors 118).

In various examples, memory write information 102 is based on information (e.g., write information 112A-112N, collectively “write information 112,” described below) generated by management unit 122 of processors 120 during execution of operating system 114 and/or software modules 116. Management unit 122 may comprise a hardware component of processors 120 that is configured to manage data retrieved from and data written to memory 103. Operating system 114 may provide memory write information 102 to software modules 116, such as upon request by software modules 116. Software modules 116 may then determine, based on memory write information 102, whether or not software modules 116 will perform garbage collection (e.g., using garbage collectors 118) on any of objects 106.

As shown in FIG. 1, memory 103 may optionally store a table 108. Table 108 may include one or more memory storage area table entries 110A-110N (collectively, “table entries 110”). Each of table entries 110 includes respective write information that may be included or otherwise stored in memory write information 102. For example, as shown, memory storage area table entry 110A may include write information 112A, and memory storage area table entry 110N may include write information 112N.

In various examples, each entry of memory storage area table entries 110 may be associated with a storage area of memory storage areas 104. (For example, as shown in FIG. 2, when table 108 comprises a page table, each page table entry may be associated with a page of memory.) Management unit 122 may use table 108 to identify one or more of memory storage areas 104 for use during execution of operating system 114 and/or software modules 116. For example, each of memory storage area table entries 110 may map a virtual address to a physical address within memory storage areas 104, as will be described in more detail within the context of the example shown in FIG. 2.

The write information included within each of memory storage area table entries 110 indicates whether or not processors 120 have written any data to the respective storage area of memory storage areas 104 since a prior point in time. Management unit 122 may generate write information 112 during execution of operating system 114 and/or software modules 116. Each of objects 106 may be stored in one or more of memory storage areas 104. Write information 112 for memory storage area table entries 110 may be included in memory write information 102. For example, in certain examples, at various points in time during execution, operating system 114 may retrieve and store at least a portion of write information 112 within memory write information 102. Operating system 114 may provide memory write information 102 to software modules 116, such as, for example, upon request by software modules 116.

As one example, memory write information 102 may indicate that processors 120 (e.g., during execution of operation system 114 and/or software modules 116) has not written any data to a particular storage area of storage areas 104 since a prior point in time, such as a prior time at which garbage collection was previously performed by one or more of garbage collectors 118. The particular storage area may include, for example, object 106A. Based on this indication of memory write information 102, one or more of software modules 116 may determine (e.g., using one or more of garbage collectors 118) to refrain from performing garbage collection on another object (e.g., object 106N), where object 106N may, in this non-limiting example, be referenced by object 106A. In this example, given that the particular storage area has not been written to or changed since the last time garbage collection was performed on memory storage areas 104, given that object 106A is included in the particular storage area, and given that object 106A references object 106N, garbage collectors 118 may determine to refrain from performing garbage collection on object 106N. Garbage collectors 118 may determine to refrain from performing such garbage collection, in some instances, upon further determining that object 106A is currently reachable (e.g., currently referenced by another object of objects 106 or by a process executable by processors 120, such as operating system 114 and/or software modules 116).

In fact, in this example, garbage collectors 118 may determine to refrain to performing garbage collection on any of a group of different objects that are referenced by object 106A. In this case, object 106A may be referred to as a parent object, and the objects referenced by object 106A may be referred to as child objects of object 106A. In such fashion, garbage collectors 118 may make use of memory write information 102, provided by management unit 122, to determine that any objects previously referenced by object 106A, since the prior garbage collection process, continue to be referenced by object 106A, and that none of these child objects are to be garbage collected during the current garbage collection process. This determination may improve the efficiency of the process performed by garbage collectors 118, as they do not necessarily need to traverse each of these child objects individually to determine whether or not they are to be garbage collected. The streamlined determination may also be particularly useful when there are a large number of child objects of object 106A (e.g., a large list of objects).

FIG. 2 is a block diagram illustrating another example of the computing device 200 that is configured to determine whether or not to perform garbage collection on one or more objects, in accordance with one or more aspects of the present disclosure. Computing device 200 is one non-limiting example of computing device 100 shown in FIG. 1. In this example, computing device 200 includes one or more processors 220. Processors 220 include a memory management unit (MMU) 222. Memory 203 of computing device 200 includes one or more pages 204, page table 208, operating system 214, and a virtual machine 216. (MMU 222 is one example of management unit 122 shown in FIG. 1, pages 204 are one example of memory storage areas 104, page table 208 is one example of table 108, operating system 214 is one example of operating system 114, and virtual machine 216 is an example of one of software modules 116.)

MMU 222 may comprise a hardware component of processors 220 that is configured to manage data retrieved from and data written to memory 203. MMU 222 is configured to provide a mapping from virtual to physical addresses within memory 203. Physical addresses are addresses used by memory 203 (e.g., within physical random access memory (RAM)), while virtual addresses are addresses used by particular processes executed by processors 220, such as by operating system 214 and/or virtual machine 216. MMU 222 translates the virtual addresses into physical addresses using page table 208.

Pages 204 include one or more physical pages within memory 203. In one non-limiting example, each page of pages 204 is four thousand ninety six bytes in size. Pages 204 store one or more objects 206A-206N (collectively, “objects 206”). Each object of objects 206 is stored in one or more of pages 206. For example, any given object of objects 206 may be stored completely within one page of pages 204, or it may span across multiple pages.

Page table 208 includes one or more page table entries 210A-210N (collectively, “page table entries 210”). Each page table entry is associated with a page of pages 204, and includes a respective address and dirty bit. For example, as shown in FIG. 2, page table entry 210A includes address 211A and dirty bit 212A, while page table entry 210N includes address 211N and dirty bit 212N.

MMU 222 may use the page table entries of page table 208 to map virtual addresses to physical addresses. As one example, MMU 222 may use a given virtual address as an index into page table 208 to identify page table entry 210A that corresponds to this virtual address. MMU 222 may then identify address 211A of page table entry 210A as a physical address that corresponds to the given virtual address. In particular, the virtual address may be an address of a virtual page in a virtual memory space used or accessed by one or more processes (e.g., operating system 214 and/or virtual machine 216), and the physical address may be an address of a physical page of pages 204 in memory 203. In such fashion, MMU 222 may use page table entries 210 to map virtual pages of a virtual memory space to pages 204 within memory 203.

As shown in FIG. 2, each of page table entries 210 includes a respective dirty bit. For instance, page table 210A includes dirty bit 212A, and page table entry 210N includes dirty bit 212N. These dirty bits are updated by MMU 222 during execution of operating system 214 and/or virtual machine 216, with no additional performance cost to operating system 214 and virtual machine 216. As one non-limiting example, during execution of virtual machine 216, MMU 222 may set dirty bit 212A to a value of true, or “1,” when a particular virtual page associated with page table entry 210A has been written by virtual machine 216. This dirty bit 212A is associated with this particular virtual page, and it is also associated with address 211A (e.g., physical address) of a physical page of pages 204 in memory 203. When dirty bit 212A is set to “1,” dirty bit 212A indicates that the particular virtual page and the corresponding physical page associated with address 211A, within pages 204, have been written to by virtual machine 216. Conversely, if dirty bit 212A is set to false, or “0,” the virtual page and corresponding physical page have not been written to by virtual machine 216.

In certain examples, each of page table entries 210 may also include an accessed bit, separate from the dirty bit. MMU 222 may set the accessed bit of a given page table entry when the corresponding virtual page has been written to or read by operating system 214 and/or virtual machine 216. In various examples, the dirty bits and access bits may never be cleared, but they may be used by operating system 214 (e.g., by kernel 215) to perform internal memory management (e.g., for determining which pages of a memory-mapped file have changed and thus can be saved to one or more storage devices).

Operating system 214 and/or virtual machine 216 may utilize the settings of dirty bits 212A-212N (collectively, “dirty bits 212”) to improve the efficiency of garbage collection performed by one or more garbage collectors 218 or virtual machine 216. For example, at various points in time during execution of operating system 214 (e.g., on context switches away from processes executed by processors 220, such as virtual machine 216), kernel 215 of operating system may copy one or more of dirty bits 212 from respective page table entries 210 into bitfield information 202. Bitfield information 202 may comprise one example of memory write information 102 shown in FIG. 1. In some cases, kernel 215 may copy of all dirty bits 212 into bitfield information 202. In other cases, kernel 215 may only copy select ones of dirty bits 212 into bitfield information 202 for a given address range (e.g., address range for certain ones of virtual pages corresponding to pages 204 in memory 203).

Kernel 215 may provide or otherwise include an application programming interface (API) to read and/or clear bitfield information 202. For example, the API provided by kernel 215 may allow virtual machine 216 to atomically read and/or clear bitfield information 202. To allow such atomic operations, in some examples, kernel 215 may maintain two separate copies or instances of a bitfield for bitfield information 202 that are used when interacting with virtual machine 216 via this API.

In some non-limiting examples, at the end of each garbage collection cycle or process, virtual machine 216 may use the API with kernel 215 to clear bitfield information 202, setting the values of the dirty bits for a given address range (or, alternatively, the values of all of the dirty bits in bitfield information 202) to “0.” When it is time for garbage collectors 218 to perform a subsequent garbage collection process, virtual machine 216 may use the API to receive bitfield information 202 from kernel. In some cases, virtual machine 216 may receive all of the dirty bits included in bitfield information 202 associated with page table entries 210. In other cases, virtual machine 216 may request dirty bits for a given address range in bitfield information 202 (e.g., address range for certain ones of virtual pages corresponding to pages 204 in memory 203).

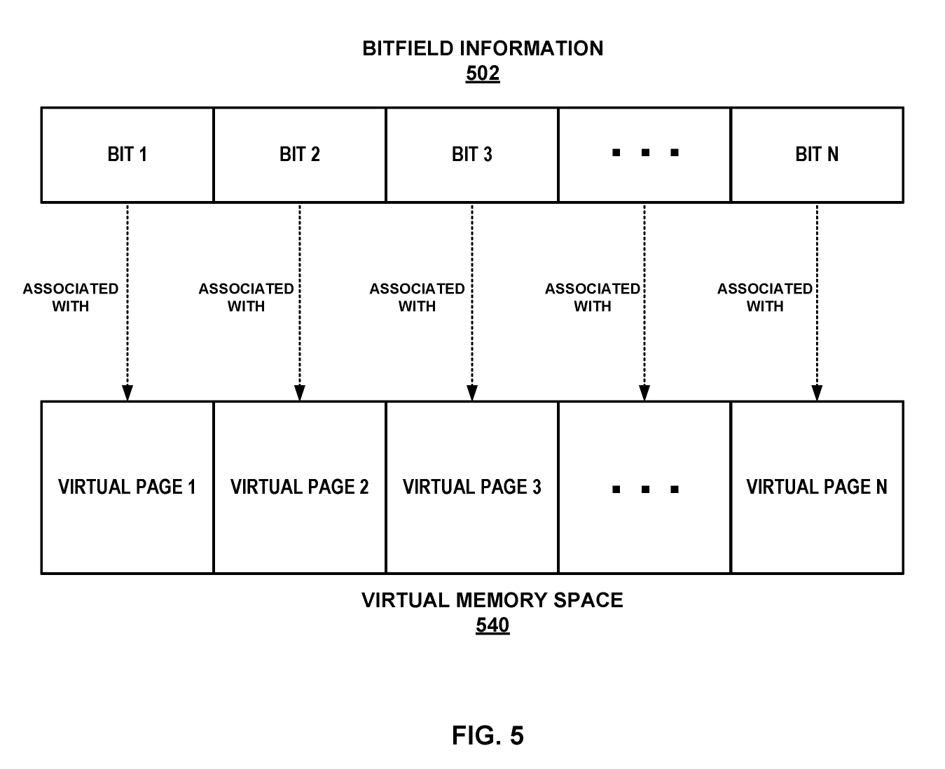

Upon receiving bitfield information 202 that includes one or more of dirty bits 212, virtual machine 216 may be able to determine which virtual pages have not been written to since the last time garbage collectors 218 performed garbage collection. Virtual machine 216 may do so by determining which dirty bits within bitfield information 202 are set to “0.” In various examples, as will be described further in reference to FIG. 5, each dirty bit included in bitfield information 202 may be associated with a respective virtual page. By determining which dirty bits in bitfield information 202 are set to “0,” virtual machine 216 is capable of identifying which corresponding virtual pages have not been written to since garbage collectors 218 last performed garbage collection. Virtual machine 216 is capable of identifying particular virtual pages based upon corresponding virtual addresses and, in various examples, based on the size of each virtual page (e.g., 4096 bytes per page).

Virtual machine 216 is also capable of identifying which ones of objects 206 are accessible in which virtual pages based upon the virtual addresses and/or virtual address ranges associated with these objects, and, in various examples, further based on the virtual page size. Thus, based upon which dirty bits in bitfield information 202 are set to “0,” virtual machine 216 may determine which ones of objects 206 are associated with pages that have not been written to since garbage collectors 218 last performed garbage collection. Assuming these objects are still reachable and referenced in memory 203 by another object or process, garbage collectors 218 may determine that these objects should not be garbage collected. Furthermore, if these objects are parent objects that reference one or more child objects, garbage collectors 218 may determine, based on the dirty bit setting of “0” associated with these parent objects included in bitfield information 202, that the child objects also should also not be garbage collected. Thus, the use of bitfield information 202 allows garbage collectors 218 to significantly prune the tree of objects that are traversed to determine which ones of these objects are reachable and should therefore not be garbage collected.

As one non-limiting example, bitfield information 202 may include a dirty bit setting for dirty bit 212A of page table 210A in page table 208. Dirty bit 212A may be associated with a virtual page that maps to one of physical pages 204 having address 211A and that stores object 206A. Dirty bit 212A may be set to “0,” indicating that this virtual page and the corresponding physical page having address 211A has not been written to. Because virtual machine 216 knows that the object 206A is associated with this virtual page (e.g., based upon the virtual address associated with object 206A) but with no other virtual pages, virtual machine 216 is able to determine that object 206A has not been written to since the last time garbage collection was performed. Virtual machine 216 may be able to determine that object 206A is only associated with this virtual page based, for example, on the size of object 206A and the size of each virtual page.

Continuing with this example, if object 206A holds a reference to object 206N, and if garbage collectors 218 determine that object 206A is still reachable (e.g., referenced by another object or process), garbage collectors 218 may determine that object 206N is still reachable and referenced by object 206A, and therefore that garbage collectors 218 should refrain from performing garbage collection on object 206N (which, in this example, is a child object of parent object 206A). Furthermore, if object 206A includes references to multiple child objects (e.g., a list of objects), garbage collectors 218 may determine to refrain from performing garbage collection of any of these child objects. Garbage collectors 218 are able to make such determinations without necessarily having to maintain any additional state information about objects 206, but instead utilizing bitfield information 202 that is based on settings of dirty bits 212 that are provided by MMU 222.

In some instances, a particular object of objects 206 may span across multiple ones of pages 204. For example, based on its size, an object 206B of objects 206 may span across multiple ones of physical pages 204 stored in memory 203, and therefore object 206B may be associated with multiple virtual pages. In this example, virtual machine 216 may identify the multiple virtual pages that are associated with object 206B and which corresponding dirty bits in bitfield information 202 are associated with these virtual pages. If each of these dirty bits is set to “0,” virtual machine 216 may determine that object 206B has not been written to since the last iteration of garbage collection, because none of the virtual pages associated with object 206B have been written to. In this case, assuming object 206B is reachable, garbage collectors 218 may determine to refrain from performing garbage collection on object 206B and any of objects 206 that may be referenced by object 206B (e.g., child objects of object 206B).

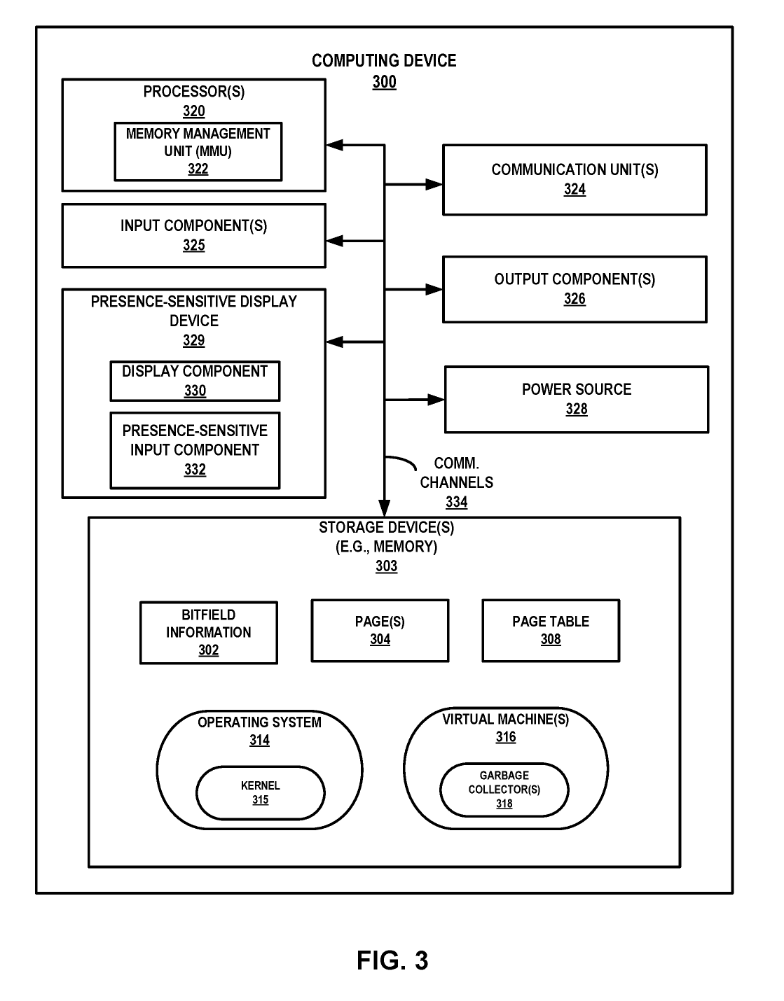

FIG. 3 is a block diagram illustrating an example of a computing device 300, in accordance with one or more aspects of present disclosure. Computing device 300 shown in FIG. 3 may be one example of computing device 100 (FIG. 1) and/or computing device 200 (FIG. 2). FIG. 3 illustrates only one particular example of computing device 300, and many other examples of computing device 300 may be used in other instances and may include a subset of the components included in example computing device 300 or may include additional components not shown in FIG. 3.

In the example of FIG. 3, computing device 300 includes presence-sensitive display device 329, one or more processors 320, one or more input components 325, one or more communication units 324, one or more output components 326, a power source 328, and one or more storage devices 303. Storage devices 303 may include or otherwise be one example of memory 103 or memory 203 shown in FIGS. 1 and 2, respectively.

Communication channels 334 may interconnect each of the components 320, 324, 325, 326, 328, 329, and/or 302 for inter-component communications (physically, communicatively, and/or operatively). In some examples, communication channels 334 may include a system bus, a network connection, an inter-process communication data structure, or any other method for communicating data between hardware and/or software.

One or more input components 325 of computing device 300 may receive input, such as input from a user. Examples of input are tactile, audio, and video input. Examples of input components 325 include a presence-sensitive screen, touch-sensitive screen, touchscreen, mouse, keyboard, trackpad, voice responsive system, video camera, microphone or any other type of device for detecting input from a human or machine.

One or more output components 326 of computing device 300 may generate output. Examples of output are tactile, audio, and video output. Examples of output components 326 include a presence-sensitive screen, touch-sensitive screen, touchscreen, sound card, video graphics adapter card, speaker, cathode ray tube (CRT) display, liquid crystal display (LCD), or any other type of device for generating output to a human or machine.

One or more communication units 324 of computing device 300 may communicate with external devices via one or more networks by transmitting and/or receiving network signals on the one or more networks (e.g., one or more wired and/or wireless networks). For example, computing device 300 may use communication units 324 to transmit and/or receive radio signals on a radio network such as a cellular radio network. Likewise, communication units 324 may transmit and/or receive satellite signals on a satellite network such as a global positioning system (GPS) network. Examples of communication units 324 include network interface cards (e.g. such as an Ethernet card), optical transceivers, radio frequency transceivers, GPS receivers, or any other type of device that can send and/or receive information. Other examples of communication units 324 may include short wave radios, cellular data radios, wireless Ethernet network radios, as well as universal serial bus (USB) controllers. In some examples, computing device 300 may use communication units 224 to communicate with remote device 112 illustrated in FIG. 1.

Presence-sensitive display device 329 of computing device 300 includes display component 330 and presence-sensitive input component 332. In some examples, presence-sensitive display device 329 may provide output to a user using tactile, audio, or video stimuli as described above with reference to output components 326. For example, display component 330 may provide display or video output as described with reference to output components 326. Presence-sensitive display device 329 may also provide input capabilities such as that described above with reference to input components 325. For example, presence-sensitive input component 332 may provide input capabilities as described with reference to input components 325.

Display component 330 may be a screen at which information is displayed by presence-sensitive display device 329, and presence-sensitive input component 332 may detect an object at and/or near display component 330. As one example range, presence-sensitive input component 332 may detect an object, such as a finger or stylus that is within two inches or less of display component 330. Presence-sensitive input component 332 may determine a location (e.g., an [x,y] coordinate) of display component 330 at which the object was detected. In another example range, presence-sensitive input component 332 may detect an object six inches or less from display component 330 and other ranges are also possible. Presence-sensitive input component 332 may determine the location of display component 330 selected by a user's finger using capacitive, inductive, and/or optical recognition techniques. In some examples, presence sensitive input component 332 also provides output to a user using tactile, audio, or video stimuli as described with respect to display component 330. Display component 330 may be any type of output device that provides visual output, such as described with respect to output components 326.

While illustrated as an internal component of computing device 300, presence-sensitive display device 329 may also represent an external component that shares a data path with computing device 300 for transmitting and/or receiving input and output. For instance, in one example, presence-sensitive display device 329 represents a built-in component of computing device 300 located within and physically connected to the external packaging of computing device 300 (e.g., a screen on a mobile phone). In another example, presence-sensitive display device 329 represents an external component of computing device 300 located outside and physically separated from the packaging of computing device 300 (e.g., a monitor and/or a projector that shares a wired and/or wireless data path with a tablet computer).

Presence-sensitive display device 329 of computing device 300 may detect two-dimensional and/or three-dimensional gestures as input from a user of computing device 300. For instance, a sensor of presence-sensitive display device 329 (e.g., sensor of presence-sensitive input component 332) may detect a user's movement (e.g., moving a hand, an arm, a pen, a stylus) within a threshold distance of the sensor of presence-sensitive display device 329. Presence-sensitive display device 329 may determine a two- or three-dimensional vector representation of the movement and correlate the vector representation to a gesture input (e.g., a hand-wave, a pinch, a clap, a pen stroke) that has multiple dimensions. In other words, presence-sensitive display device 329 can detect a multi-dimension gesture without requiring the user to gesture at or near a screen or surface (e.g., display component 330) at which presence-sensitive display device 329 outputs information for display. Instead, presence-sensitive display device 329 can detect a multi-dimensional gesture performed at or near a sensor which may or may not be located near the screen or surface at which presence-sensitive display device 329 outputs information for display.

One or more storage devices 303 within computing device 300 may store information for processing during operation of computing device 300 (e.g., during execution of one or more of operating system 314 or virtual machines 316). In some examples, storage devices 303 include temporary memory, meaning that a primary purpose of storage devices 303 is not long-term storage. Storage devices 303 on computing device 300 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 303, in some examples, include one or more computer-readable storage media. Storage devices 303 may be configured to store larger amounts of information than volatile memory. Storage devices 303 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 303 may store program instructions and/or data associated with operating system 314, including kernel 315, and/or one or more virtual machines 316, including garbage collectors 318. Operating system 314 may be one example of operating system 114 (FIG. 1) or operating system 214 (FIG. 2), while one or more of virtual machines 316 may be examples of software modules 116 (FIG. 1) or virtual machine 216 (FIG. 2).

As shown in FIG. 3, computing device 300 may include a power source 328. In some examples, power source 328 may be a battery. Power source 328 may provide power to one or more components of computing device 300. Non-limiting examples of power source 328 may include, but are not necessarily limited to, batteries having zinc-carbon, lead-acid, nickel cadmium (NiCd), nickel metal hydride (NiMH), lithium ion (Li-ion), and/or lithium ion polymer (Li-ion polymer) chemistries. In some examples, power source 328 may have a limited capacity (e.g., 1000-3000 mAh).

One or more processors 320 may implement functionality and/or execute instructions within computing device 300. For example, processors 320 on computing device 300 may receive and execute instructions stored by storage devices 303 that execute the functionality of operating system 314 and/or virtual machines 316. These instructions executed by processors 320 may cause computing device 300 to store information within storage devices 303 during program execution. Processors 320 may execute instructions of operating system 314 and virtual machines 316 to perform one or more operations. That is, operating system 314 and virtual machines 316 may be operable by processors 320 to perform various functions described herein.

As shown in FIG. 3, processors 320 include MMU 322. MMU 322 may be one example of management unit 122 (FIG. 1) and/or MMU 222 (FIG. 2).

In some examples, computing device 300 may only comprise or otherwise include processors 320. In these examples, input components 325, presence-sensitive display device 329, communication units 324, output components 326, power source 328, and storage devices 303 may be external to, yet communicatively coupled with (e.g., via communication channels 334), computing device 300.

As shown in FIG. 3, storage devices 303 may also be configured to store bitfield information 302, one or more pages 304 of memory, and page table 308. Bitfield information 302 may be one example of memory write information 102 (FIG. 1) or bitfield information 202 (FIG. 2). Pages 304 may be one example of memory storage areas 104 (FIG. 1) or pages 204 (FIG. 2). Page table 308 may be one example of table 108 (FIG. 1) or page table 208 (FIG. 2).

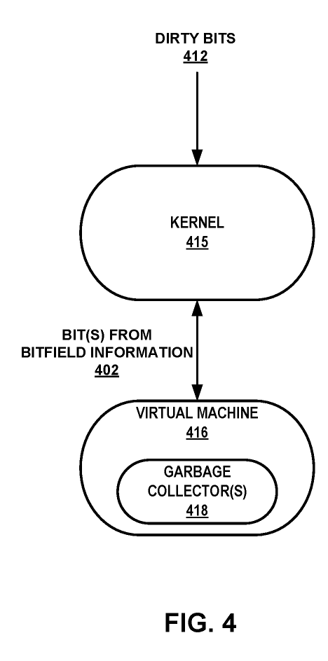

FIG. 4 is a block diagram illustrating an example of a virtual machine 416 receiving bits of bitfield information 402 from a kernel 415 to determine whether or not to perform garbage collection on one or more objects, in accordance with one or more aspects of present disclosure. In FIG. 4, kernel 415 may be one example of kernel 215 (FIG. 2) and/or kernel 315 (FIG. 3). Virtual machine 416 may be one example of virtual machine 216 (FIG. 2) and/or one of virtual machines 316 (FIG. 3). Virtual machine 416 may include one or more garbage collectors 418.

As illustrated in FIG. 4, kernel 415 may receive dirty bits 412. Dirty bits 412 may be one example of dirty bits 212 (FIG. 2). For instance, in some cases, kernel 415 may retrieve dirty bits 412 from respective page table entries of a page table (e.g., page table 208 shown in FIG. 2) at various points in time during execution (e.g., on context switches away from processes executed by processors 220). Kernel 415 may then include these dirty bits 412 within bitfield information 402, which may be one example of bitfield information 202 (FIG. 2) and/or bitfield information 302 (FIG. 3). Each of dirty bits 412 included in bitfield information 402 is associated with a respective virtual page of a virtual memory space, such as described in the examples above. A respective value of each dirty bit included in bitfield information 402 indicates whether or not virtual machine 416 has written any data to the respective virtual page since the prior point in time (e.g., since the last time at which one or more of garbage collectors 418 performed garbage collection).

Virtual machine 416 may request one or more bits of bitfield information 402, such as when it is time to perform a garbage collection process. For example, as shown in FIG. 4, virtual machine 416 may request (e.g., via atomic read operation, as described previously) one or more bits of bitfield information 402 for use during the next iteration of garbage collection performed by garbage collectors 418.

In some cases, virtual machine 416 may request all of the bits included in bitfield information 402. In some cases, virtual machine 416 may only request a group of dirty bits 412 that are associated with a given address range or with certain virtual pages. For example, virtual machine 416 may only request a group of dirty bits 412 that are associated with a virtual address range associated with certain objects or virtual pages of interest. In this example, virtual machine 416 may specify a particular address range in the request to kernel 415. Kernel 415 may then provide those ones of dirty bits 412 to virtual machine 416, in response to the request, such as, for example, within bitfield information 402. However, if virtual machine 416 does not specify a particular address range in the request, kernel 415 may, in various examples, provide all of dirty bits 412 within bitfield information 402 that is provided to virtual machine 416.

In some cases, kernel 415 maintains bitfield information 402 in memory, such as in memory 203 (FIG. 2). In these cases, virtual machine 416 may not directly access bitfield information 402, but may only request the data included in bitfield information 402 from kernel 415. Kernel 415 may, in various examples, be configured to set the dirty bits 412 included within bitfield information 402, but may not be configured to clear any of these bits. In these examples, virtual machine 416 may request, at one or more points in time, to clear one or more of the dirty bit settings in bitfield information 402. For instance, after garbage collectors 418 have performed an iteration of garbage collection, virtual machine 416 may send a request to clear the dirty bit settings of bitfield information 402 (e.g., a request to clear all dirty bits in bitfield information 402, a request to clear dirty bits for a given address range or dirty bits associated with selected virtual pages within bitfield information 402). By doing so, at a later point in time, such as when it is time to perform a subsequent iteration of garbage collection, virtual machine 416 may again request bitfield information 402 from kernel 415 to determine which dirty bits have been set since the last time garbage collection was performed. These dirty bits are associated with virtual pages that have been written to (e.g., by virtual machine 416) since the last time garbage collection was performed.

FIG. 5 is a conceptual diagram illustrating example associations between bits included in bitfield information 502 and respective virtual pages of a virtual memory space 540, in accordance with one or more aspects of present disclosure. In FIG. 5, bitfield information 502 may be one example of memory write information 102 (FIG. 1), bitfield information 202 (FIG. 2), bitfield information 302 (FIG. 3), and/or bitfield information 402 (FIG. 4). Virtual memory space 540 is a virtual memory area that is associated with a physical memory, such as memory 103 (FIG. 1), memory 203 (FIG. 2), and/or memory 303 (FIG. 3). The virtual pages included in virtual memory space 540 are virtual memory pages that are associated with physical memory areas, such as memory storage areas 104 (FIG. 1), pages 204 (FIG. 2), and/or pages 304 (FIG. 3).

As illustrated in the example of FIG. 5, bitfield information 502 may comprise a data structure that includes a plurality of bits (e.g., dirty bits). In this example, each bit of bitfield information 502 is associated with a respective virtual page of memory within virtual memory space 540. Thus, “bit 1” of bitfield information 502 is associated with “virtual page 1” of virtual memory space 540; “bit 2” of bitfield information 502 is associated with “virtual page 2;” “bit 3” of bitfield information 502 is associated with “virtual page 3;” and “bit n” of bitfield information 502 is associated with “virtual page n.” In one example, “virtual page 1” through “virtual page N” occur in sequential, increasing order within virtual memory space 540, where the order of “bit 1” through “bit N” in bitfield information 502 matches the order of “virtual page 1” through “virtual page N.” Each of “virtual page 1” through “virtual page N” may have the same page size, according to various examples.

As described previously, a software module (e.g., one of software modules 116), such as a virtual machine (e.g., virtual machine 216, one of virtual machines 316, virtual machine 416), may receive bitfield information 502 from an operating system (e.g., operating system 114, kernel 215, kernel 315, kernel 415), such as on request by the software module. For purposes of illustration only, it may be assumed that virtual machine 416 periodically requests bitfield information 502 from kernel 415, as illustrated in FIG. 4, where bitfield information 502 is one example of bitfield information 402. In this example, upon receiving bitfield information 502, virtual machine 416 is able to determine which bits (e.g., dirty bits) included in bitfield information 502 are associated with which virtual pages of virtual memory space 540. Because there is a 1-1 association between bits and virtual pages in the example of FIG. 5, virtual machine 416 is able to determine, for each virtual page of virtual memory space 540, based on the bit associated with this respective virtual page, whether or not any data has been written to this virtual page.

For instance, virtual machine 416 determines whether or not any data has been written to “virtual page 1” based on the setting of “bit 1” (e.g., dirty bit setting of zero indicates no data has been written to “virtual page 1,” dirty bit setting of one indicates that data has been written to “virtual page 1”). If virtual machine 416 determines that no data has been written to “virtual page 1” since the last time garbage collection was performed, garbage collectors 418 of virtual machine 416 may determine to refrain from performing garbage collection on any objects (e.g., child objects) that are referenced by an object (e.g., parent object) that is included within “virtual page 1,” assuming that the object associated with “virtual page 1” is referenced by another object and not orphaned (e.g., that it is reachable). In such fashion, by knowing that a parent object is included within “virtual page 1,” and also that “virtual page 1” has not been written to or changed, based on the setting of “bit 1,” virtual machine 416 is able to determine that any child objects referenced by this parent object are still reachable and therefore should not be garbage collected.

Similarly, virtual machine 416 determines whether or not any data has been written to “virtual page 2” based on the setting of “bit 2,” determines whether or not any data has been written to “virtual page 3” based on the setting of “bit 3,” and determines whether or not any data has been written to “virtual page n” based on the setting of “bit n.” Virtual machine 416 is also able to determine which objects are associated with which one or more of “virtual page 1” through “virtual page n” based on the virtual addresses of these objects and the virtual addresses that correspond with the different virtual pages in virtual memory space 540, along with the virtual page size and object size.

As described previously, virtual machine 416 may request bitfield information 502 from kernel 415. In various examples, virtual machine 416 may make this request each time garbage collectors 418 are to perform another iteration of garbage collection. In some cases, virtual machine 416 may request all of the bits that included in bitfield information 502. In other cases, virtual machine 416 may request only those bits of bitfield information 502 that correspond to a given address range of virtual memory space 540. For example, virtual machine 416 may only request “bit 1” and “bit 2” of bitfield information 502 that correspond to the address range for “virtual page 1” and “virtual page 2” of virtual memory space 540. In this example, kernel 415 may only provide the values of “bit 1” and “bit 2” in bitfield information 502 that is sent to virtual machine 416.

In some examples, kernel 415 may provide an API to virtual machine 416 to allow virtual machine 416 to request bitfield information 502. This API may, in various examples, provide an atomic read operation to allow virtual machine 416 to read bitfield information 502 that is stored in memory and controlled by kernel 415. In these examples, to support atomic read operations, kernel 415 may maintain two different copies of bitfield information 502.

Furthermore, the API may allow virtual machine 416 to clear bitfield information 502 (e.g., via an atomic clear operation). For example, each time after virtual machine 416 reads bitfield information 502 from kernel 415, such as when it is time to perform garbage collection, virtual machine 416 may use the API provided by kernel 415, after reading bitfield information 502, to clear the settings of bits included in bitfield information 502. In some cases, virtual machine 416 may clear all bits of bitfield information 502, while in other cases, it may clear those bits of bitfield information that are associated with virtual pages of virtual memory space 540 corresponding to a particular address range. By clearing the values of one or more bits included in bitfield information 502 each time garbage collection is performed, virtual machine 416 may later be able to determine, during a subsequent iteration of garbage collection, which virtual pages of virtual memory space 540 have been written to since the prior iteration of garbage collection, based on the settings of the bits included in bitfield information 502.

In certain examples, bitfield information 502 may also include accessed bits, which are separate from dirty bits. Accessed bits indicate whether a corresponding virtual page has either been written to or read. In these examples, each accessed bit is associated with a respective virtual page. In the example of FIG. 5, for example, if “bit 1” of bitfield information 502 is a first dirty bit, bitfield information 502 may also include a first accessed bit that is also associated with “virtual page 1.” Similarly, while “bit 2” may be a second dirty bit associated with “virtual page 2,” bitfield information 502 may further include a second accessed bit that is also associated with “virtual page 2.” Continuing with this example, “bit 3” may be a third dirty bit associated with “virtual page 3,” and bitfield information 502 may further include a third accessed bit that is also associated with “virtual page 3.” “bit n” may be an nth dirty bit associated with “virtual page N,” and bitfield information 502 may also include an nth accessed bit that is also associated with “virtual page N.”

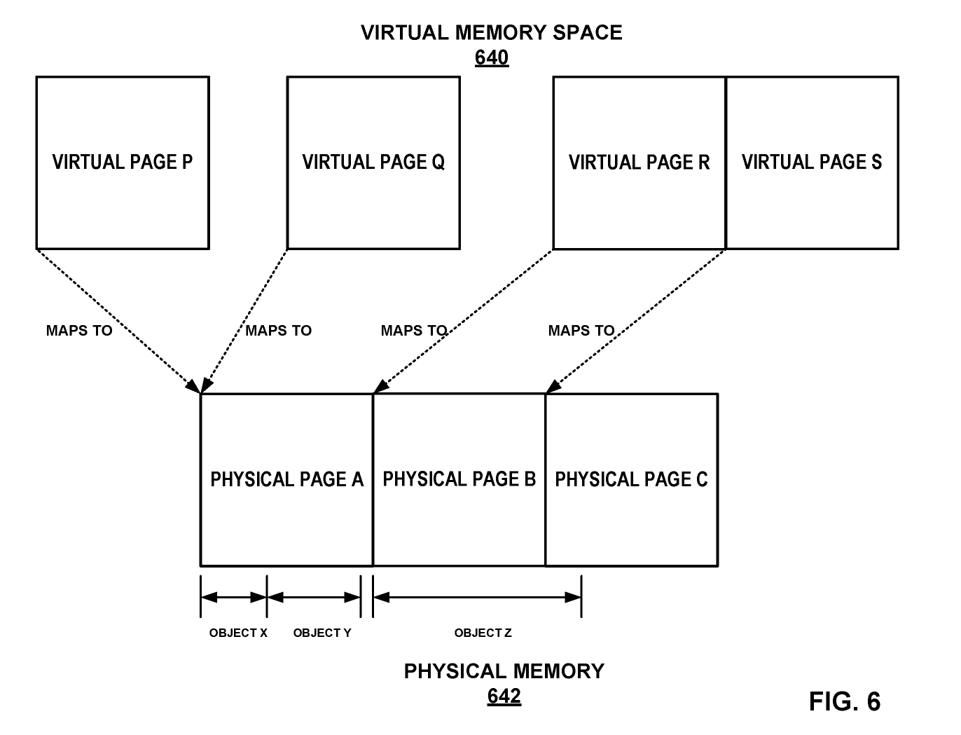

FIG. 6 is a conceptual diagram illustrating example mappings of virtual pages of a virtual memory space 640 to respective physical pages of a physical memory 642, in accordance with one or more aspects of present disclosure. For purposes of illustration only, the example of FIG. 6 will again be described in reference to virtual machine 416. In the example of FIG. 6, multiple different virtual addresses corresponding to different virtual pages may be mapped to a single physical address corresponding to a single physical page. In some cases, the example of FIG. 6 may be used in a sixty-four bit addressing/processing architecture.

In the example of FIG. 5, it is possible that multiple different objects may be associated with and included within the same virtual page. If virtual machine 416 determines that the virtual page has been written to, it is possible that only one of these multiple different objects have been written to, while the remaining objects have not. Because all of the objects are associated with the same virtual page, however, virtual machine 416 may not be able to discriminate which objects of this page have been written to and which ones have not.

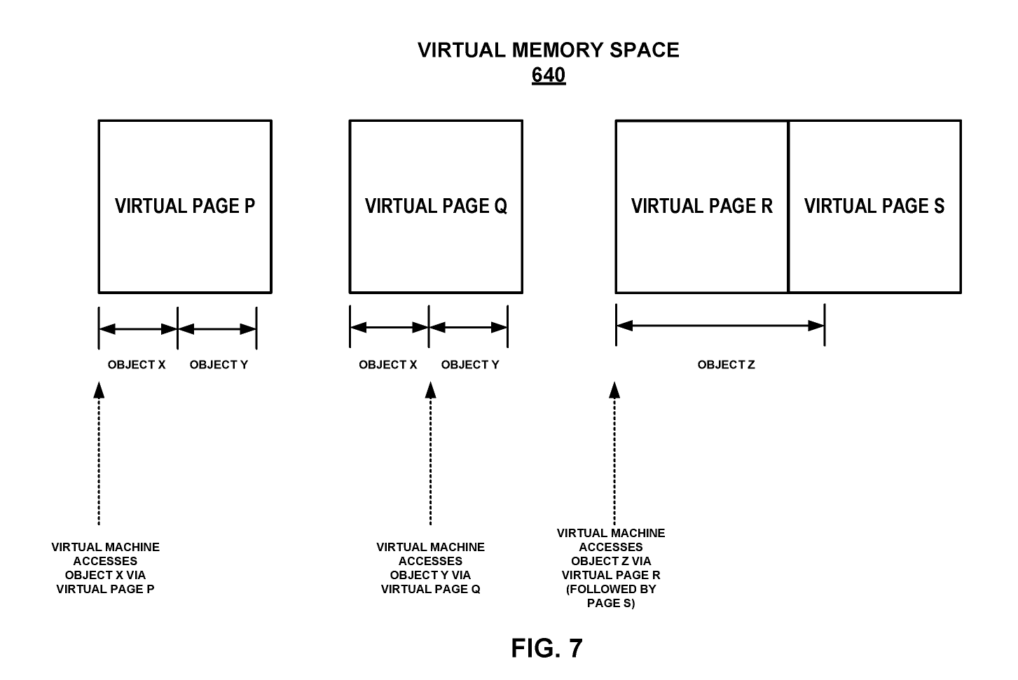

Using the example of FIG. 6 and also FIG. 7, however, virtual machine 416 may be able to determine exactly which objects have been written to and which ones have not, because each object may be uniquely associated with a particular virtual page by virtual machine 416. As shown in the illustrative example of FIG. 6, virtual memory space 640 includes four distinct virtual pages, namely “virtual page P,” “virtual page Q,” “virtual page R,” and “virtual page S.” Physical memory 642 includes three distinct physical pages, namely “physical page A,” “physical page B,” and “physical page C.” Physical memory 642 may be one example of or otherwise included within a memory (e.g., memory 103 of FIG. 1, memory 203 of FIG. 2, memory 303 of FIG. 3).

A management unit (e.g., management unit 122 of FIG. 1, MMU 222 of FIG. 2, MMU 322 of FIG. 3) may use a table (e.g., table 108 of FIG. 1, page table 208 of FIG. 2, page table 308 of FIG. 3), via corresponding table entries, to map both “virtual page P” and “virtual page Q” to “physical page A.” Thus, in this example, each of “virtual page P” and “virtual page Q” are mapped to the same physical page, namely “physical page A.” The management unit may map “virtual page R” to “physical page B,” and may also map “virtual page S” to “physical page C.”

In the example of FIG. 6, three example objects that are stored in physical memory 642 are shown, namely “object X,” “object Y,” and “object Z.” “object X” and “object Y” are each stored entirely within “physical page A,” while “object Z” straddles and is stored in both “physical page B” and “physical page C.” In FIG. 6, “object X” is included at a zero offset into “physical page A,” so the virtual address of “object X” may be with virtual address of “virtual page P” with zero offset, which maps to the physical address of “physical page A” with zero offset. However, “object Y” is included at a non-zero offset into “physical page A,” so the virtual address of “object Y” may be the virtual address of “virtual page Q” with the non-zero offset, which maps to the physical address for “physical page A” with the added non-zero offset. “object Z” straddles “physical page B” and “physical page C,” as it is included in both of these pages. However, “object Z” is included at a zero offset into “physical page B,” so the virtual address of “object Z” may be the virtual address of “virtual page R” with zero offset, which maps to the physical address of “physical page B” with zero offset.

In this example, the management unit creates a memory mapping using a table (e.g., table 108, page table 208, page table 308) such that each object has its own associated virtual page. Thus, during execution of virtual machine 416, virtual machine 416 uses the virtual address of “virtual page P” with zero offset to access “object X,” while virtual machine 416 uses the virtual address of “virtual page Q” with the specified non-zero offset to access “object Y.” Virtual machine 416 also uses the virtual address of “virtual page R” with zero offset to access “object Z.” Since “object Z” straddles both “physical page B” and “physical page C,” “virtual page R” and “virtual page S” may comprise contiguous virtual pages in the virtual memory space.

Continuing with the example of FIG. 6, FIG. 7 is a conceptual diagram illustrating an example layout of objects stored in virtual pages of virtual memory space 640, in accordance with one or more aspects of present disclosure. As illustrated in FIG. 7, “virtual page P” and “virtual page Q” may or may not be contiguous within virtual memory space 640, while “virtual page R” and “virtual page S” are contiguous. As shown in FIG. 6, both “virtual page P” and “virtual page Q” map to “physical page A,” and “physical page A” stores both “object X” and “object Y.” Thus, as shown in FIG. 7, “object X” and “object Y” are associated with “virtual page P” and also with “virtual page Q.” Thus, in theory, both “object X” and “object Y” can be accessed via two separate virtual pages. However, in the examples of FIGS. 6 and 7, the management unit and table (e.g., page table) are utilized such that each object is accessed via a particular virtual page.

Thus, when “object X” is created by virtual machine 416, virtual machine 416 receives the virtual address of “virtual page P” with zero offset to access “object X,” while virtual machine 416 receives the virtual address of “virtual page Q” with the specified non-zero offset to access “object Y.” Virtual machine 416 may receive these virtual addresses, in various examples, from the management unit (e.g., MMU 322 shown in FIG. 3) or from the operating system (e.g., operating system 314). During execution, virtual machine 416 may access “object X” only via “virtual page P,” and virtual machine 416 may access “object Y” only via “virtual page Q.” In such fashion, in various examples, each virtual page is associated with one object as accessed by virtual machine 416. Because each virtual page may have a one-to-one association with individual dirty bit settings of the bitfield information (e.g., as shown with bitfield information 502 in FIG. 5), virtual machine 416 may access each object via one or more unique, respective virtual pages of virtual memory space 640, and virtual machine 416 may therefore uniquely associate one or more dirty bits included in the bitfield information with a respective object. (In the example of FIG. 7, both “virtual page R” and “virtual page S,” along with their respective dirty bits, are associated with “object Z.”)

In this case, virtual machine 416 may, when processing the bitfield information (e.g., bitfield information 502), determine whether each object has or has not been written to since the last time garbage collection was performed, and thus garbage collectors 418 of virtual machine 416 may potentially be able to avoid determining object reachability for objects that are referenced by a parent object that has not been written to or changed since garbage collection was previously performed.

For instance, virtual machine 416 may identify the dirty bit in the bitfield information that is associated with “virtual page P,” such as, for example, based on the virtual address of “virtual page P” and the corresponding ordered location of the dirty bit within the bitfield information, as described in the example of FIG. 5, wherein the ordering of the bits corresponds to the ordering of the virtual pages. Since “object X” is uniquely associated with “virtual page P,” virtual machine 416 may determine, based on the value of the respective dirty bit for “virtual page P,” whether or not any data has been written to “object X” since the last time garbage collection was performed.

If, for example, the respective dirty bit is set to “0,” virtual machine 416 may determine that no data has been written to “object X.” If “object X” is a parent object that references one or more child objects, virtual machine 416 may identify that these child objects are still reachable, given that no data for “object X” has changed, and that garbage collectors 418 are to refrain from performing garbage collection on any of these child objects (e.g., assuming that “object X” is itself reachable and still referenced by another object).

When “object Z” is created by virtual machine 416, virtual machine 416 receives the virtual address of “virtual page R” with zero offset to access “object Z.” During execution, virtual machine 416 may access “object Z” via “virtual page R,” which is followed by “virtual page S,” given that “object Z” spans both virtual pages. In this example, “object Z” may span multiple pages given the size of “object Z” being greater than the virtual page size. Even so, each virtual page is still associated with a given object (e.g., “virtual page R” and “virtual page S” are each associated with a given object, namely “object Z”), and virtual machine 416 is configured to access “object Z” via “virtual page R” (which is followed by “virtual page S”).

However, given that “object Z” spans both of these virtual pages, virtual machine 416 may be configured to review both the dirty bit of the bitfield information that is associated with “virtual page R” as well as the dirty bit that is associated with “virtual page S.” If both of these dirty bits are set to “0,” then virtual machine 416 may determine that no data has been written to “object Z.”

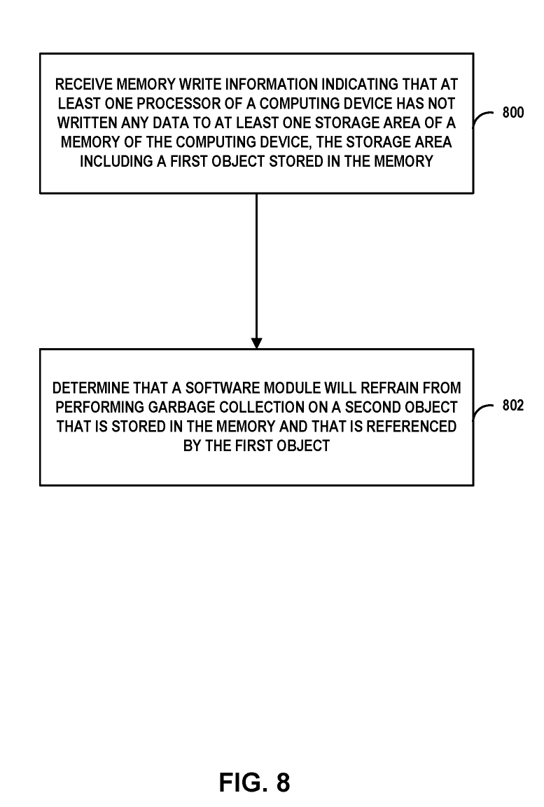

FIG. 8 is a flowchart illustrating example operations of a computing device, such as computing device 200, computing device 200, and/or computing device 300 shown in FIG. 1, FIG. 2, and FIG. 3, respectively, in accordance with one or more aspects of the present disclosure. For purposes of illustration only, the operations of FIG. 8 are described with reference to computing device 100 shown in FIG. 1.

A software module (e.g., one of software modules 116) that is executed by at least one processor (e.g., one or more of processors 120) of a computing device (e.g., computing device 100) may receive (800) memory write information (e.g., memory write information 102) indicating whether or not the at least one processor has written any data to a storage area (e.g., a storage area of storage areas 104) of a memory (e.g., memory 103) of the computing device since a prior point in time. The memory write information is associated with the storage area and is generated by a management unit (e.g., management unit 122) of the computing device, wherein the management unit comprises a hardware component of the at least one processor that is configured to manage data retrieved from and data written to the memory. The storage area includes a first object (e.g., object 106A) that is stored in the memory. The software module determines (802), based on the memory write information, whether or not the software module will perform garbage collection on a second object (e.g., object 106N) that is stored in the memory and that is referenced by the first object.

### EXAMPLE 1

A method comprising: receiving, by a software module that is executed by at least one processor of a computing device, memory write information indicating that the at least one processor has not written any data to a storage area of a memory of the computing device since a prior point in time, wherein the memory write information is associated with the storage area and is based on information generated by a management unit of the computing device, wherein the management unit comprises a hardware component of the at least one processor that is configured to manage data retrieved from and data written to the memory, and wherein the storage area includes a first object that is stored in the memory; and determining, by the software module and based on the memory write information, to refrain from performing garbage collection on a second object that is stored in the memory and that is referenced by the first object.

### EXAMPLE 2

The method of Example 1, wherein the memory write information further indicates whether or not the at least one processor has written any data to one or more additional storage areas of the memory since the prior point in time, the memory write information being further associated with each of the one or more additional storage areas.

### EXAMPLE 3

The method of any of Examples 1-2, wherein determining to refrain from performing garbage collection on the second object is further based on determining, by the software module, that the first object is currently referenced by a third object that is stored in the memory.

### EXAMPLE 4

The method of any of Examples 1-3, wherein the first object references a plurality of objects stored in the memory that are different from the first object, wherein the plurality of objects includes the second object, and wherein the method further comprises: determining, by the software module and based on the memory write information, to refrain from performing garbage collection on the plurality of objects that are each referenced by the first object.

### EXAMPLE 5

The method of any of Examples 1-4, wherein the memory write information indicates that the at least one processor has not written any data to the storage area of the memory of the computing device since the prior point in time when the software module previously performed garbage collection on at least one object stored in the memory.

### EXAMPLE 6

The method of any of Examples 1-5, wherein the software module comprises a virtual machine that includes one or more garbage collectors, wherein the management unit comprises a memory management unit (MMU), wherein receiving the memory write information comprises receiving, by the virtual machine, the memory write information from a kernel of an operating system executed by the at least one processor, and wherein determining to refrain from performing garbage collection on the second object comprises determining, by the virtual machine and based on the memory write information received from the kernel, that the one or more garbage collectors of the virtual machine will refrain from performing garbage collection on the second object.

### EXAMPLE 7

The method of any of Examples 1-6, wherein the memory includes a plurality of storage areas and a table having a plurality of table entries that are associated with the plurality of storage areas, wherein the storage area is included in the plurality of storage areas and is associated with a table entry included in the plurality of table entries, and wherein the table entry includes the information generated by the management unit.

### EXAMPLE 8

The method of Example 7, wherein the plurality of storage areas comprise physical pages stored in the memory, wherein the table comprises a page table having a plurality of page table entries that are associated with the plurality of physical pages, wherein the storage area comprises a physical page that is associated with a page table entry of the plurality of page table entries, wherein the physical page includes the first object, and wherein the management unit uses the plurality of page table entries of the page table to map virtual pages of a virtual memory space to the physical pages stored in the memory.

### EXAMPLE 9

The method of Example 8, wherein the page table entry maps a virtual page of the virtual memory space to the physical page, wherein the information included in the page table entry comprises a dirty bit that is associated with the virtual page and that is generated by the management unit to indicate that the at least one processor has not written any data to the virtual page since the prior point in time.

### EXAMPLE 10

The method of Example 9, wherein a kernel of an operating system executed by the at least one processor retrieves the dirty bit and includes it within bitfield information, wherein receiving the memory write information comprises receiving, by the software module and from the kernel, the bitfield information that includes the dirty bit associated with the virtual page, and wherein determining to refrain from performing garbage collection on the second object comprises: determining, by the software module, that the first object is associated with the virtual page, the virtual page being associated with the dirty bit included in the bitfield information; and determining, by the software module and based on a value of the dirty bit included in the bitfield information, that the software module will refrain from performing garbage collection on the second object that is referenced by the first object.

### EXAMPLE 11

The method of Example 10, wherein the kernel retrieves each of a plurality of dirty bits, including the dirty bit, from a respective page table entry of the page table, wherein the kernel includes the plurality of dirty bits within the bitfield information, wherein each dirty bit included within the bitfield information is associated with a respective virtual page of the virtual memory space, and wherein a respective value of each dirty bit included in the bitfield information indicates whether or not the at least one processor has written any data to the respective virtual page since the prior point in time.

### EXAMPLE 12

The method of Example 11, wherein the software module accesses each object stored in the memory via one or more unique virtual pages of the virtual memory space, wherein the software module uniquely associates one or more dirty bits included in the bitfield information with a respective object, and wherein the dirty bit is uniquely associated with the first object, the first object being associated with the virtual page.

### EXAMPLE 13

The method of Example 12, wherein the virtual page comprises a first virtual page, wherein the page table maps both the first virtual page and a second virtual page of the virtual memory space to the physical page stored in the memory, and wherein the software module accesses the first object only via the first virtual page but not via the second virtual page.

### EXAMPLE 14

A computing device comprising: a memory; and at least one processor communicatively coupled to the memory, the at least one processor including a management unit comprising a hardware component that is configured to manage data retrieved from and data written to the memory, wherein the at least one processor is programmed to: receive memory write information indicating that the at least one processor has not written any data to a storage area of a memory of the computing device since a prior point in time, wherein the memory write information is associated with the storage area and is based on information generated by a management unit of the computing device, and wherein the storage area includes a first object that is stored in the memory; and determine, based on the memory write information, to refrain from performing garbage collection on a second object that is stored in the memory and that is referenced by the first object.

### EXAMPLE 15

The computing device of Example 14, wherein the first object references a plurality of objects stored in the memory that are different from the first object, wherein the plurality of objects includes the second object, and wherein the at least one processor is further programmed to: determine, based on the memory write information, to refrain from performing garbage collection on the plurality of objects that are each referenced by the first object.

### EXAMPLE 16

The computing device of any of Examples 14-15, wherein the at least one processor is programmed to implement a virtual machine that includes one or more garbage collectors, wherein the management unit comprises a memory management unit (MMU), wherein the virtual machine is configured to receive the memory write information from a kernel of an operating system executed by the at least one processor, and wherein the virtual machine is configured to determine, based on the memory write information received from the kernel, that the one or more garbage collectors of the virtual machine will refrain from performing garbage collection on the second object.

### EXAMPLE 17

The computing device of any of Examples 14-16, wherein the memory includes a plurality of storage areas and a table having a plurality of table entries that are associated with the plurality of storage areas, wherein the storage area is included in the plurality of storage areas and is associated with a table entry included in the plurality of table entries, and wherein the table entry includes the information generated by the management unit.

### EXAMPLE 18

The computing device of Example 17, wherein the plurality of storage areas comprise physical pages stored in the memory, wherein the table comprises a page table having a plurality of page table entries that are associated with the plurality of physical pages, wherein the storage area comprises a physical page that is associated with a page table entry of the plurality of page table entries, wherein the physical page includes the first object, and wherein the management unit uses the plurality of page table entries of the page table to map virtual pages of a virtual memory space to the physical pages stored in the memory.

### EXAMPLE 19

The computing device of Example 18, wherein the page table entry maps a virtual page of the virtual memory space to the physical page, wherein the information included in the page table entry comprises a dirty bit that is associated with the virtual page and that is generated by the management unit to indicate that the at least one processor has not written any data to the virtual page since the prior point in time.

### EXAMPLE 20

The computing device of Example 19, wherein a kernel of an operating system executed by the at least one processor retrieves the dirty bit and includes it within bitfield information, wherein the at least one processor programmed to receive the memory write information is further programmed to receive, from the kernel, the bitfield information that includes the dirty bit associated with the virtual page, and wherein the at least one processor programmed to determine to refrain from performing garbage collection on the second object is further programmed to: determine that the first object is associated with the virtual page, the virtual page being associated with the dirty bit included in the bitfield information; and determine, based on a value of the dirty bit included in the bitfield information, to refrain from performing garbage collection on the second object that is referenced by the first object.

### EXAMPLE 21

The computing device of Example 20, wherein the kernel retrieves each of a plurality of dirty bits, including the dirty bit, from a respective page table entry of the page table, wherein the kernel includes the plurality of dirty bits within the bitfield information, wherein each dirty bit included within the bitfield information is associated with a respective virtual page of the virtual memory space, and wherein a respective value of each dirty bit included in the bitfield information indicates whether or not the at least one processor has written any data to the respective virtual page since the prior point in time.

### EXAMPLE 22

The computing device of Example 21, wherein the at least one processor is further programmed to: access each object stored in the memory via one or more unique virtual pages of the virtual memory space; and uniquely associate one or more dirty bits included in the bitfield information with a respective object, and wherein the dirty bit is uniquely associated with the first object, the first object being associated with the virtual page.

### EXAMPLE 23

The computing device of Example 22, wherein the virtual page comprises a first virtual page, wherein the page table maps both the first virtual page and a second virtual page of the virtual memory space to the physical page stored in the memory, and wherein the at least one processor is further programmed to access the first object only via the first virtual page but not via the second virtual page.

### EXAMPLE 24

The computing device of any of Examples 14-23, wherein the memory write information further indicates whether or not the at least one processor has written any data to one or more additional storage areas of the memory since the prior point in time, the memory write information being further associated with each of the one or more additional storage areas.

### EXAMPLE 25

The computing device of any of Examples 14-24, wherein the at least one processor programmed to determine to refrain from performing garbage collection on the second object is further programmed to determine that the first object is currently referenced by a third object that is stored in the memory.

### EXAMPLE 26

The computing device of any of Examples 14-25, wherein the memory write information indicates that the at least one processor has not written any data to the storage area of the memory of the computing device since the prior point in time when the software module previously performed garbage collection on at least one object stored in the memory.

### EXAMPLE 27

The computing device of Example 14, further comprising means for performing the method of any of Examples 2-13.

### EXAMPLE 28

A computing device comprising means for performing the method of any of Examples 1-13.

### EXAMPLE 29

A computer-readable storage device storing instructions that, when executed, cause at least one processor of a computing device to perform operations comprising: receiving memory write information indicating that the at least one processor has not written any data to a storage area of a memory of the computing device since a prior point in time, wherein the memory write information is associated with the storage area and is based on information generated by a management unit of the computing device, wherein the management unit comprises a hardware component of the at least one processor that is configured to manage data retrieved from and data written to the memory, and wherein the storage area includes a first object that is stored in the memory; and determining, based on the memory write information, to refrain from performing garbage collection on a second object that is stored in the memory and that is referenced by the first object.

### EXAMPLE 30

The computer-readable storage device of Example 29, wherein the memory write information further indicates whether or not the at least one processor has written any data to one or more additional storage areas of the memory since the prior point in time, the memory write information being further associated with each of the one or more additional storage areas.

### EXAMPLE 31

The computer-readable storage device of any of Examples 29-30, wherein determining to refrain from performing garbage collection on the second object is further based on determining that the first object is currently referenced by a third object that is stored in the memory.

### EXAMPLE 32

The computer-readable storage device of any of Examples 29-31, wherein the first object references a plurality of objects stored in the memory that are different from the first object, wherein the plurality of objects includes the second object, and wherein the operations further comprise: determining, based on the memory write information, to refrain from performing garbage collection on the plurality of objects that are each referenced by the first object.

### EXAMPLE 33

The computer-readable storage device of any of Examples 29-32, wherein the memory write information indicates that the at least one processor has not written any data to the storage area of the memory of the computing device since the prior point in time when the software module previously performed garbage collection on at least one object stored in the memory.

### EXAMPLE 34

The computer-readable storage device of any of Examples 29-33, wherein the management unit comprises a memory management unit (MMU), wherein receiving the memory write information comprises receiving, by a virtual machine that includes one or more garbage collectors, the memory write information from a kernel of an operating system executed by the at least one processor, and wherein determining to refrain from performing garbage collection on the second object comprises determining, by the virtual machine and based on the memory write information received from the kernel, that the one or more garbage collectors of the virtual machine will refrain from performing garbage collection on the second object.

### EXAMPLE 35

The computer-readable storage device of any of Examples 29-34, wherein the memory includes a plurality of storage areas and a table having a plurality of table entries that are associated with the plurality of storage areas, wherein the storage area is included in the plurality of storage areas and is associated with a table entry included in the plurality of table entries, and wherein the table entry includes the information generated by the management unit.

### EXAMPLE 36

The computer-readable storage device of Example 35, wherein the plurality of storage areas comprise physical pages stored in the memory, wherein the table comprises a page table having a plurality of page table entries that are associated with the plurality of physical pages, wherein the storage area comprises a physical page that is associated with a page table entry of the plurality of page table entries, wherein the physical page includes the first object, and wherein the management unit uses the plurality of page table entries of the page table to map virtual pages of a virtual memory space to the physical pages stored in the memory.

### EXAMPLE 37

The computer-readable storage device of Example 36, wherein the page table entry maps a virtual page of the virtual memory space to the physical page, wherein the information included in the page table entry comprises a dirty bit that is associated with the virtual page and that is generated by the management unit to indicate that the at least one processor has not written any data to the virtual page since the prior point in time.

### EXAMPLE 38

The computer-readable storage device of Example 37, wherein a kernel of an operating system executed by the at least one processor retrieves the dirty bit and includes it within bitfield information, wherein receiving the memory write information comprises receiving, from the kernel, the bitfield information that includes the dirty bit associated with the virtual page, and wherein determining to refrain from performing garbage collection on the second object comprises: determining that the first object is associated with the virtual page, the virtual page being associated with the dirty bit included in the bitfield information; and determining, based on a value of the dirty bit included in the bitfield information, to refrain from performing garbage collection on the second object that is referenced by the first object.

### EXAMPLE 39

The computer-readable storage device of Example 38, wherein the kernel retrieves each of a plurality of dirty bits, including the dirty bit, from a respective page table entry of the page table, wherein the kernel includes the plurality of dirty bits within the bitfield information, wherein each dirty bit included within the bitfield information is associated with a respective virtual page of the virtual memory space, and wherein a respective value of each dirty bit included in the bitfield information indicates whether or not the at least one processor has written any data to the respective virtual page since the prior point in time.

### EXAMPLE 40

The computer-readable storage device of Example 39, wherein the operations further comprise: accessing each object stored in the memory via one or more unique virtual pages of the virtual memory space; and uniquely associating one or more dirty bits included in the bitfield information with a respective object, wherein the dirty bit is uniquely associated with the first object, the first object being associated with the virtual page.

### EXAMPLE 41

The computer-readable storage device of Example 40, wherein the virtual page comprises a first virtual page, wherein the page table maps both the first virtual page and a second virtual page of the virtual memory space to the physical page stored in the memory, and wherein the operations further comprise accessing the first object only via the first virtual page but not via the second virtual page.

### EXAMPLE 42

The computer-readable storage device of Example 29, wherein the instructions, when executed, further cause the at least one processor of the computing device to perform the method of any of Examples 2-13.

### EXAMPLE 43

A computer-readable storage device storing instructions that, when executed, cause at least one processor of a computing device to perform the method of any of Examples 1-13.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise Random-Access Memory (RAM), Read-Only Memory (ROM), Electrically Erasable Programmable Read-Only Memory (EEPROM), Compact Disc Read-Only Memory (CD-ROM), or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperable hardware units, including one or more processors as described above, in conjunction with suitable software and/or firmware.

It is to be recognized that, depending on the embodiment, certain acts or events of any of the methods described herein can be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
receiving, by a software module that is executed by at least one processor of a computing device, memory write information indicating that the at least one processor has not written any data to a storage area of a memory of the computing device since a prior point in time, wherein the memory write information is associated with the storage area and is based on information generated by a management unit of the computing device, wherein the management unit comprises a hardware component of the at least one processor that is configured to manage data retrieved from and data written to the memory, and wherein the storage area includes a first object that is stored in the memory; and
determining, by the software module and based on the memory write information, to refrain from performing garbage collection on a second object that is stored in the memory and that is referenced by the first object.

2. The method of claim 1, wherein the memory write information further indicates whether or not the at least one processor has written any data to one or more additional storage areas of the memory since the prior point in time, the memory write information being further associated with each of the one or more additional storage areas.

3. The method of claim 1, wherein determining to refrain from performing garbage collection on the second object is further based on determining, by the software module, that the first object is currently referenced by a third object that is stored in the memory.

4. The method of claim 1, wherein the first object references a plurality of objects stored in the memory that are different from the first object, wherein the plurality of objects includes the second object, and wherein the method further comprises:
determining, by the software module and based on the memory write information, to refrain from performing garbage collection on the plurality of objects that are each referenced by the first object.

5. The method of claim 1, wherein the memory write information indicates that the at least one processor has not written any data to the storage area of the memory of the computing device since the prior point in time when the software module previously performed garbage collection on at least one object stored in the memory.

6. The method of claim 1,
wherein the software module comprises a virtual machine that includes one or more garbage collectors,
wherein the management unit comprises a memory management unit (MMU),
wherein receiving the memory write information comprises receiving, by the virtual machine, the memory write information from a kernel of an operating system executed by the at least one processor, and
wherein determining to refrain from performing garbage collection on the second object comprises determining, by the virtual machine and based on the memory write information received from the kernel, that the one or more garbage collectors of the virtual machine will refrain from performing garbage collection on the second object.

7. The method of claim 1, wherein the memory includes a plurality of storage areas and a table having a plurality of table entries that are associated with the plurality of storage areas, wherein the storage area is included in the plurality of storage areas and is associated with a table entry included in the plurality of table entries, and wherein the table entry includes the information generated by the management unit.

8. The method of claim 7, wherein the plurality of storage areas comprise physical pages stored in the memory, wherein the table comprises a page table having a plurality of page table entries that are associated with the plurality of physical pages, wherein the storage area comprises a physical page that is associated with a page table entry of the plurality of page table entries, wherein the physical page includes the first object, and wherein the management unit uses the plurality of page table entries of the page table to map virtual pages of a virtual memory space to the physical pages stored in the memory.

9. The method of claim 8, wherein the page table entry maps a virtual page of the virtual memory space to the physical page, wherein the information included in the page table entry comprises a dirty bit that is associated with the virtual page and that is generated by the management unit to indicate that the at least one processor has not written any data to the virtual page since the prior point in time.

10. The method of claim 9,
wherein a kernel of an operating system executed by the at least one processor retrieves the dirty bit and includes it within bitfield information,
wherein receiving the memory write information comprises receiving, by the software module and from the kernel, the bitfield information that includes the dirty bit associated with the virtual page, and
wherein determining to refrain from performing garbage collection on the second object comprises:
determining, by the software module, that the first object is associated with the virtual page, the virtual page being associated with the dirty bit included in the bitfield information; and
determining, by the software module and based on a value of the dirty bit included in the bitfield information, that the software module will refrain from performing garbage collection on the second object that is referenced by the first object.

11. The method of claim 10,
wherein the kernel retrieves each of a plurality of dirty bits, including the dirty bit, from a respective page table entry of the page table,
wherein the kernel includes the plurality of dirty bits within the bitfield information,
wherein each dirty bit included within the bitfield information is associated with a respective virtual page of the virtual memory space, and
wherein a respective value of each dirty bit included in the bitfield information indicates whether or not the at least one processor has written any data to the respective virtual page since the prior point in time.

12. The method of claim 11,
wherein the software module accesses each object stored in the memory via one or more unique virtual pages of the virtual memory space,
wherein the software module uniquely associates one or more dirty bits included in the bitfield information with a respective object, and
wherein the dirty bit is uniquely associated with the first object, the first object being associated with the virtual page.

13. The method of claim 12,
wherein the virtual page comprises a first virtual page,
wherein the page table maps both the first virtual page and a second virtual page of the virtual memory space to the physical page stored in the memory, and
wherein the software module accesses the first object only via the first virtual page but not via the second virtual page.

14. A computing device comprising:
a memory; and
at least one processor communicatively coupled to the memory, the at least one processor including a management unit comprising a hardware component that is configured to manage data retrieved from and data written to the memory,
wherein the at least one processor is programmed to:
receive memory write information indicating that the at least one processor has not written any data to a storage area of a memory of the computing device since a prior point in time, wherein the memory write information is associated with the storage area and is based on information generated by a management unit of the computing device, and wherein the storage area includes a first object that is stored in the memory; and
determine, based on the memory write information, to refrain from performing garbage collection on a second object that is stored in the memory and that is referenced by the first object.

15. The computing device of claim 14, wherein the first object references a plurality of objects stored in the memory that are different from the first object, wherein the plurality of objects includes the second object, and wherein the at least one processor is further programmed to:
determine, based on the memory write information, to refrain from performing garbage collection on the plurality of objects that are each referenced by the first object.

16. The computing device of claim 14,
wherein the at least one processor is programmed to implement a virtual machine that includes one or more garbage collectors,
wherein the management unit comprises a memory management unit (MMU),
wherein the virtual machine is configured to receive the memory write information from a kernel of an operating system executed by the at least one processor, and
wherein the virtual machine is configured to determine, based on the memory write information received from the kernel, that the one or more garbage collectors of the virtual machine will refrain from performing garbage collection on the second object.

17. The computing device of claim 14, wherein the memory includes a plurality of storage areas and a table having a plurality of table entries that are associated with the plurality of storage areas, wherein the storage area is included in the plurality of storage areas and is associated with a table entry included in the plurality of table entries, and wherein the table entry includes the information generated by the management unit.

18. The computing device of claim 17, wherein the plurality of storage areas comprise physical pages stored in the memory, wherein the table comprises a page table having a plurality of page table entries that are associated with the plurality of physical pages, wherein the storage area comprises a physical page that is associated with a page table entry of the plurality of page table entries, wherein the physical page includes the first object, and wherein the management unit uses the plurality of page table entries of the page table to map virtual pages of a virtual memory space to the physical pages stored in the memory.

19. The computing device of claim 18, wherein the page table entry maps a virtual page of the virtual memory space to the physical page, wherein the information included in the page table entry comprises a dirty bit that is associated with the virtual page and that is generated by the management unit to indicate that the at least one processor has not written any data to the virtual page since the prior point in time.

20. The computing device of claim 19,
wherein a kernel of an operating system executed by the at least one processor retrieves the dirty bit and includes it within bitfield information,
wherein the at least one processor programmed to receive the memory write information is further programmed to receive, from the kernel, the bitfield information that includes the dirty bit associated with the virtual page, and
wherein the at least one processor programmed to determine to refrain from performing garbage collection on the second object is further programmed to:
determine that the first object is associated with the virtual page, the virtual page being associated with the dirty bit included in the bitfield information; and
determine, based on a value of the dirty bit included in the bitfield information, to refrain from performing garbage collection on the second object that is referenced by the first object.

21. The computing device of claim 20,
wherein the kernel retrieves each of a plurality of dirty bits, including the dirty bit, from a respective page table entry of the page table,
wherein the kernel includes the plurality of dirty bits within the bitfield information,
wherein each dirty bit included within the bitfield information is associated with a respective virtual page of the virtual memory space, and
wherein a respective value of each dirty bit included in the bitfield information indicates whether or not the at least one processor has written any data to the respective virtual page since the prior point in time.

22. The computing device of claim 21,
wherein the at least one processor is further programmed to:
access each object stored in the memory via one or more unique virtual pages of the virtual memory space; and
uniquely associate one or more dirty bits included in the bitfield information with a respective object, and
wherein the dirty bit is uniquely associated with the first object, the first object being associated with the virtual page.

23. The computing device of claim 22,
wherein the virtual page comprises a first virtual page,
wherein the page table maps both the first virtual page and a second virtual page of the virtual memory space to the physical page stored in the memory, and
wherein the at least one processor is further programmed to access the first object only via the first virtual page but not via the second virtual page.

24. A computer-readable storage device storing instructions that, when executed, cause at least one processor of a computing device to perform operations comprising:
receiving memory write information indicating that the at least one processor has not written any data to a storage area of a memory of the computing device since a prior point in time, wherein the memory write information is associated with the storage area and is based on information generated by a management unit of the computing device, wherein the management unit comprises a hardware component of the at least one processor that is configured to manage data retrieved from and data written to the memory, and wherein the storage area includes a first object that is stored in the memory; and
determining, based on the memory write information, to refrain from performing garbage collection on a second object that is stored in the memory and that is referenced by the first object.

25. The computer-readable storage device of claim 24, wherein the first object references a plurality of objects stored in the memory that are different from the first object, wherein the plurality of objects includes the second object, and wherein the operations further comprise:
determining, based on the memory write information, to refrain from performing garbage collection on the plurality of objects that are each referenced by the first object.
